(19) United States
(12) Patent Application Publication
(10) Pub. No.: US 2013/0327775 A1
(43) Pub. Date: Dec. 12, 2013

(54) Trash Receptacle Securing System

(71) Applicant: Jonathan Diaz, Poughkeepsie, NY (US)

(72) Inventor: Jonathan Diaz, Poughkeepsie, NY (US)

(21) Appl. No.: 13/484,309

(22) Filed: May 31, 2012

Related U.S. Application Data
(60) Provisional application No. 61/519,886, filed on Jun. 1, 2011.

(51) Int. Cl. B65F 1/00; B65F 1/16; B65F 1/14; B65F 1/12

(52) U.S. Cl. 220/315; 220/630; 220/810

(57) ABSTRACT

A trash receptacle securing system is provided and comprises a trash receptacle having an open top and a closed bottom. At least one aperture is formed in the closed bottom of the trash receptacle. A mounting base is provided having a top surface and a bottom surface. At least one nub is formed on the top surface of the mounting base with the nub receivable within the at least one aperture and releasably contactable with the closed bottom of the trash receptacle. A foot release mechanism moves the at least one nub in a generally outward direction within the at least one aperture and out of contact with the closed bottom of the trash receptacle. Upon activation of the foot release means, the trash receptacle is separable from the mounting base.

The present application claims the benefit of priority of pending provisional patent application Ser. No. 61/519,886, filed on Jun. 1, 2011, entitled “Trash Lock”.

### BACKGROUND OF THE INVENTION

1. Field of the Invention

This invention relates generally to a trash receptacle securing system and, more particularly, the invention relates to a trash receptacle securing system providing garbage and recycling receptacles together with a specially designed mounting base that maintains the trash receptacle firmly in place.

2. Description of the Prior Art

As useful and necessary as outside garbage and recycling receptacles are, their use does present a couple of drawbacks. Particularly, even when these bins are loaded down with trash and other items, they can easily be knocked over. All it takes is a particularly strong gust of wind to send the container spiraling down the street, its contents sprung free from their confines to litter the landscape. The resulting mess is obviously an unpleasant job for the homeowner, who has to retrieve the rubbish strewn all over the yard and the street. Not only can it be annoying and frustrating to chase down the can and subsequently pick up the mess, but bulky, errant refuse can also present a safety hazard for oncoming traffic. If a car is forced to swerve out of the way of a garbage bag or a collection of empty milk jugs, an accident could possibly result. Outside receptacles are not only susceptible to wind. Large, stray animals searching for a quick meal can easily tip over these containers, sending the lid flying and leaving behind a backyard mess for homeowners. In addition to the risk of errant garbage, the receptacle lid itself can be irretrievably lost, resulting in people having to shell out money for replacement bins.

### SUMMARY

The present invention is a trash receptacle securing system comprising a trash receptacle having an open top and a closed bottom. At least one aperture is formed in the closed bottom of the trash receptacle. A mounting base is provided having a top surface and a bottom surface. At least one nub is formed on the top surface of the mounting base with the nub receivable within the at least one aperture and releasably contactable with the closed bottom of the trash receptacle. A foot release mechanism moves the at least one nub in a generally outward direction within the at least one aperture and out of contact with the closed bottom of the trash receptacle. Upon activation of the foot release means, the trash receptacle is separable from the mounting base.

In addition, the present invention includes a trash receptacle securing system comprising a trash receptacle having an open top and a closed bottom. A pair of apertures is formed in the closed bottom of the trash receptacle. A mounting base is provided having a top surface and a bottom surface. A pair of nubs is formed on the top surface of the mounting base with one nub receivable within one aperture and each nub releasably contactable with the closed bottom of the trash receptacle. Foot release means moves the nubs in a generally outward direction within the apertures and out of contact with the closed bottom of the trash receptacle. A truck release means is positioned on at least one side of the trash receptacle with the truck release means contactable with the nubs and moveable out of contact to release the trash receptacle from the mounting base. Upon activation of either the foot release means or the truck release means, the trash receptacle is separable from the mounting base.

### BRIEF DESCRIPTION OF THE DRAWINGS

FIG. 1 is an elevational front sectional view illustrating a trash receptacle securing system, constructed in accordance with the present invention, with the trash receptacle releasably secured to a mounting base;

FIG. 2 is a bottom plan view illustrating the trash receptacle of the trash receptacle securing system, constructed in accordance with the present invention;

FIG. 3 is a top plan view of the mounting system of the trash receptacle securing system, constructed in accordance with the present invention;

FIG. 4 is a bottom plan view of the mounting base of the trash receptacle securing system, constructed in accordance with the present invention; and

FIG. 5 is an elevational side view of the mounting base illustrating the trash receptacle securing system, constructed in accordance with the present invention.

### DETAILED DESCRIPTION OF THE PREFERRED EMBODIMENTS

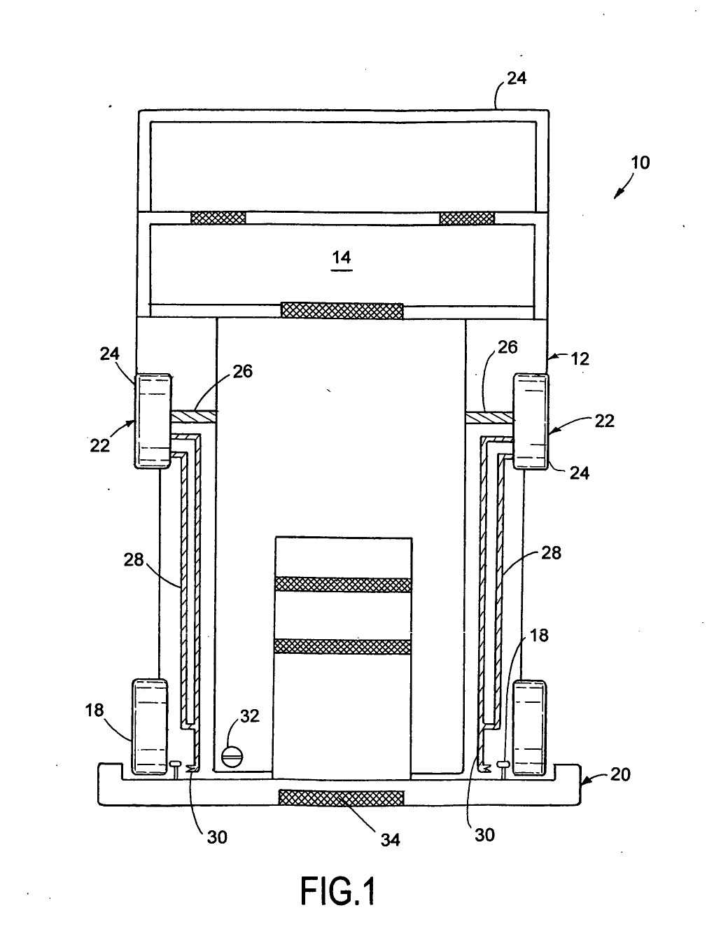

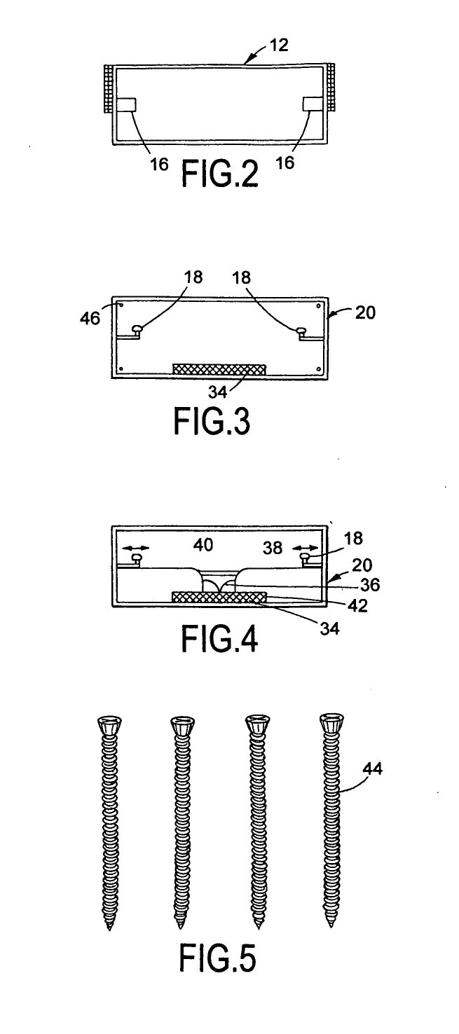

As illustrated in FIGS. 1-5, the present invention is a trash receptacle securing system, indicated generally at 10, providing garbage and recycling receptacles together with a specially designed mounting system that maintains a trash receptacle 12 firmly in place. The trash receptacle securing system 10 of the present invention includes the trash receptacle 12 constructed of a durable plastic material, measuring approximately four (4′) feet in height and approximately twenty-eight (28″) inches in width. It should be noted that while a particular size and shape trash receptacle 12 has been described and illustrated herein, it is within the scope of the present invention to provide a trash receptacle 12 of different sizes and shapes.

The trash receptacle of the trash receptacle securing system 10 of the present invention comprises the trash receptacle 12 having a lid 14. The lid 12 can be hinge-mounted to the trash receptacle 12 so that it is not easily removed by outside interference and can also be locked by simply pushing in the snap located in the front of the lid 14. On the bottom of the trash receptacle 12 is a pair of apertures 16 for releasably receiving nubs or fingers 18 on the mounting base 20. The nubs 18 interact with the apertures 16 to releasably secure the trash receptacle 12 to the mounting base 20 and are moveable to release the trash receptacle 12 from the mounting base 14, as will be described in further detail below.

In addition, the trash receptacle 12 of the trash receptacle securing system 10 of the present invention includes a truck release 22 positioned on each side of the trash receptacle 12, inside the handles 24 provided for garbage trucks, that allows the truck to easily and expediently free the trash receptacle 12 from the mounting base 20. In a preferred embodiment, the truck release 22 includes a pair of truck release buttons 24 spring-biased in a generally outward direction. A spring 26 between the truck release buttons 24 and the trash receptacle 12 accomplishes the biasing. Below the spring 26 and extending downward from each of the truck release buttons 24 is at least one securing rod 28 having a fork-like end 30. In the biased position, i.e., at rest, the fork-like end 30 of the securing rod 28 interacts with nub 18 on the mounting base 20 thereby releasably securing the trash receptacle 12 to the mounting base 20. When a garbage truck presses upon the truck release buttons 24 and overcomes the bias of the spring 26, the fork-like end 30 of the securing rod 28 releases from the nub 18 of the mounting base 20 thereby releasing the securement of the trash receptacle 12 to the mounting base 20. In a preferred embodiment, the trash receptacle 12 has two securing rods 28 for added strength and improved operation. Furthermore, the bottom front left of the trash receptacle 12 has an open and close drain hole 32 allowing water to drain through freely.

The trash receptacle securing system 10 of the present invention includes the weighted mounting base 20 sized and shaped to accommodate the bottom of the trash receptacle 12. The mounting base 20 includes a foot release pedal 34 interacting with the nubs 18 of the mounting base 20 to move the nubs 18 within the apertures 16 of the trash receptacle 12 in a general outward direction thereby disengaging the nubs 18 from the apertures 16 and fork-like ends 30 of the securing rods 28 of the trash receptacle 12. The interaction of the nubs 18 with the apertures 16 is accomplished with a pair of steel leaf springs 36 extending from the foot release pedal 36 and connected to a heavy-duty steel spring 38 which is in turn connected to steel rods 40. The steel rods 40 are connected to the nubs 18. The heavy-duty spring 38 moves the nubs 18 back to the original position after stepping on the foot release pedal 34. Also, a foot spring 42 can be positioned under the foot release pedal 34 to move the foot release pedal 34 back to its original position.

The mounting base 20 of the trash receptacle securing system 10 of the present invention has two embodiments. The first embodiment of the mounting base 20 includes a series of foot-long ground insert rods 44 insertable through insert holes 46 formed in the mounting base 20 that maintain the mounting base 20 embedded into an area of lawn. Alternatively, in a second embodiment, the mounting base 20 can be weighted down with approximately twenty-five (25 lbs.) pounds of sands for further security and has a closeable aperture allowing the mounting base 20 to be filled with the sand. This embodiment is ideal for placing the trash receptacle securing system 10 on the side of the user's home, garage, or business on the days there is no trash pickup.

There are several significant benefits and advantages associated with the trash receptacle securing system 10 of the present invention. Foremost, the trash receptacle securing system 10 provides users with a simple and effective means of steadfastly securing outside garbage and recycling containers 12. With a uniquely designed mounting base 20, the trash receptacle securing system 10 offers a handy tool in the battle against the forces that can easily uproot these receptacles 12. Prevailing against strong gusts of wind, the trash receptacle securing system 10 effectively prevents a trash receptacle 12 from being disengaged, eliminating embarrassing chases and time-consuming clean-up of strewn garbage. Moreover, users will not have to worry that their trash will fly into the path of street traffic, causing damage to other people's cars or serving as the catalyst to an accident. The trash receptacle securing system 10 will also offer an efficient deterrent to stray animals, preventing them from accessing the contents of containers when foraging for food. Comprised of minimal components, the trash receptacle securing system 10 can be installed and ready for collection in a matter of minutes. Ideal for home use, the trash receptacle securing system 10 also proves invaluable to business establishments that employ regular outside containers for their waste collection.

The trash receptacle securing system 10 of the present invention readily enhances the convenience of outside trash and recycling bins. Keeping garbage steadfastly secured, the trash receptacle securing system 10 eliminates the hassles that can sometimes plague users of these receptacles 12.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A trash receptacle securing system comprising:
a trash receptacle having an open top and a closed bottom;
at least one aperture formed in the closed bottom of the trash receptacle;
a mounting base having a top surface and a bottom surface;
at least one nub formed on the top surface of the mounting base, the nub receivable within the at least one aperture and releasably contactable with the closed bottom of the trash receptacle; and
foot release means for moving the at least one nub in a generally outward direction within the at least one aperture and out of contact with the closed bottom of the trash receptacle;
wherein upon activation of the foot release means, the trash receptacle is separable from the mounting base.

2. The trash receptacle securing system of claim 1 wherein the trash receptacle has a lid, the lid being hinge-mounted to the top of the trash. receptacle.

3. The trash receptacle securing system of claim 2 wherein the lid is releasably lockable to the trash receptacle by pushing in a snap located in a front of the lid.

4. The trash receptacle securing system of claim 1 and further comprising:
a pair of apertures formed in the closed bottom of the trash receptacle; and
a pair of nubs formed on the top surface of the mounting base;
wherein one nub is receivable within one aperture; and
wherein the release means moves both nubs in a generally outward direction within the apertures.

5. The trash receptacle securing system of claim 1 and further comprising:
truck release means positioned on at least one side of the trash receptacle for releasing the trash receptacle from the mounting base.

6. The trash receptacle securing system of claim 5 wherein the truck release means comprises:
a depressible truck release button mounted on the side of the trash receptacle;
a spring biasing the truck release button in a generally outward direction; and
at least one securing rod having a fork-like end;
wherein in the biased position, the fork-like end of the securing rod interacts with nub on the mounting base thereby releasably securing the trash receptacle to the mounting base; and
wherein upon depressing the truck release button, the bias of the spring is overcome with the fork-like end of the securing rod releases from the nub of the mounting base thereby releasing the securement of the trash receptacle to the mounting base.

7. The trash receptacle securing system of claim 6 and further comprising:
a pair of truck release means, one truck release mean positioned one side of the trash receptacle for releasing the trash receptacle from the mounting base.

8. The trash receptacle securing system of claim 1 and further comprising:
a drain hole formed in the trash receptacle; and
a cover for closing the drain hole.

9. The trash receptacle securing system of claim 4 wherein the foot release means comprises:
a foot release pedal;
a pair of steel leaf springs extending from the foot release pedal;
a coil spring connected to the leaf springs; and
steel rods connected between the coil spring and the nubs;
wherein upon depressing the foot pedal, the nubs are moved within the apertures thereby disengaging the nubs from the apertures and fork-like ends of the securing rods of the trash receptacle.

10. The trash receptacle securing system of claim 9 and further comprising:
a foot spring positioned under the foot release pedal.

11. The trash receptacle securing system of claim 1 and further comprising:
a series of ground insert rods insertable through' insert holes formed in the mounting base.

12. The trash receptacle securing system of claim 1 and further comprising:
a closeable aperture formed in the mounting base; and
an amount of sand or water introduced into the mounting base through the aperture.

13. A trash receptacle securing system comprising:
a trash receptacle having an open top and a closed bottom;
a pair of apertures formed in the closed bottom of the trash receptacle;
a mounting base having a top surface and a bottom surface;
a pair of nubs formed on the top surface of the mounting base, one nub receivable within one aperture, each nub releasably contactable with the closed bottom of the trash receptacle;
foot release means for moving the nubs in a generally outward direction within the apertures and out of contact with the closed bottom of the trash receptacle;
truck release means positioned on at least one side of the trash receptacle, the truck release means contactable with the nubs and moveable out of contact to release the trash receptacle from the mounting base;
wherein upon activation of either the foot release means or the truck release means, the trash receptacle is separable from the mounting base.

14. The trash receptacle securing system of claim 13 wherein the trash receptacle has a lid, the lid being hinge-mounted and releasably lockable to the top of the trash receptacle.

15. The trash receptacle securing system of claim 13 wherein the truck release means comprises:
a depressible truck release button mounted on the side of the trash receptacle;
a spring biasing the truck release button in a generally outward direction; and
at least one securing rod having a fork-like end;
wherein in the biased position, the fork-like end of the securing rod interacts with nub on the mounting base thereby releasably securing the trash receptacle to the mounting base; and
wherein upon depressing the truck release button, the bias of the spring is overcome with the fork-like end of the securing rod releases from the nub of the mounting base thereby releasing the securement of the trash receptacle to the mounting base.

16. The trash receptacle securing system of claim 15 and further comprising:
a pair of truck release means, one truck release mean positioned one side of the trash receptacle for releasing the trash receptacle from the mounting base.

17. The trash receptacle securing system of claim 16 wherein the foot release means comprises:
a foot release pedal;
a pair of steel leaf springs extending from the foot release pedal;
a coil spring connected to the leaf springs; and
steel rods connected between the coil spring and the nubs;
wherein upon depressing the foot pedal, the nubs are moved within the apertures thereby disengaging the nubs from the apertures and fork-like ends of the securing rods of the trash receptacle.

18. The trash receptacle securing system of claim 17 and further comprising:
a foot spring positioned under the foot release pedal.

19. The trash receptacle securing system of claim 13 and further comprising:
a series of ground insert rods insertable through insert holes formed in the mounting base.

20. The trash receptacle securing system of claim 13 and further comprising:
a closeable aperture formed in the mounting base; and
an amount of sand or water introduced into the mounting base through the aperture.
